(19) United States
(12) Patent Application Publication
(10) Pub. No.: US 2022/0174083 A1
(43) Pub. Date: Jun. 2, 2022

(54) METHOD AND DEVICE FOR DETECTING MALICIOUS ACTIVITY OVER ENCRYPTED SECURE CHANNEL

(71) Applicant: GIST (Gwangju Institute of Science and Technology), Gwangju (KR)

(72) Inventors: Hyuk LIM, Gwangju (KR); Ji Won YANG, Gwangju (KR)

(73) Assignee: GIST (Gwangju Institute of Science and Technology), Gwangju (KR)

(21) Appl. No.: 17/531,148

(22) Filed: Nov. 19, 2021

(30) Foreign Application Priority Data
Nov. 27, 2020 (KR) 10-2020-0163354

(51) Int. Cl. H04L 29/06

(52) U.S. Cl. CPC H04L 63/1425; H04L 63/0428

(57) ABSTRACT

Provided are a method and device for detecting malicious activity over an encrypted secure channel. The method includes (a) extracting at least one record from a plurality of packets each including a header and a payload and (b) determining whether the plurality of packets correspond to a malicious flow using feature information based on the at least one record.

### CROSS-REFERENCE TO RELATED APPLICATION

This application claims priority to and the benefit of Korean Patent Application No. 10-2020-0163354, filed on Nov. 27, 2020, the disclosure of which is incorporated herein by reference in its entirety.

### BACKGROUND

### 1. Field of the Invention

The present invention relates to a method and device for detecting malicious activity over an encrypted secure channel, and more particularly, to a method and device for detecting malicious activity through record analysis.

### 2. Discussion of Related Art

With the wide proliferation of malicious and illegal activities through the Internet, network security is continuously attracting attention. Over the last ten years, local, enterprise, and cloud networks have experienced serious security accidents including distributed denial-of-service (DDoS) attacks or ransomware attacks.

In terms of the amount of stolen data which is sensitive to users and monetary losses that people have to spend on recovery, the results are serious. Moreover, the rates of variation and spread of malicious activities and attacks have almost exceeded an organizational ability to respond immediately, and cyberspaces are gradually being pushed back by malicious attack campaigns involving unspecified individuals or groups.

Undoubtedly, most malicious activities are now being found on web-based platforms. Malicious actors lure targets through common weaponized resources (e.g., fake websites, malicious ads, or phishing email), and some malicious actors actively exploit vulnerabilities in legitimate web applications or plug-ins to insert malicious scripts which redirect accesses to abnormal domains.

An intrusion starts when an unfortunate user accesses one of these attack toolkit suppliers and a prepared executable file is forcibly installed on the system. Once a malicious code is successively transferred to the target system, the malicious code establishes a foothold in the victim's network by connecting to a command and control (C&C) server.

Then, the C&C server controls numerous host devices such that a credential may be filled out or the service or infrastructure of the target may be disrupted.

Accordingly, several intra-network services, such as a firewall and an intrusion detection system (IDS), currently provide security protection against this kind of security risk, but the security performance is insufficient.

### SUMMARY OF THE INVENTION

The present invention is directed to providing a method and device for detecting malicious activity over an encrypted secure channel.

The present invention is also directed to providing a method and device for extracting feature information from protocol data units (PDUs) of a secure socket layer (SSL) such as an SSL record.

The present invention is also directed to providing a method and device for examining discriminative characteristics in the sequence of feature vectors arranged in order of record arrival.

Objects of the present invention are not limited to those described above, and other objects which have not been described will be clearly understood from the following descriptions.

According to an aspect of the present invention, there is provided a method of detecting malicious activity over an encrypted secure channel, the method including (a) extracting at least one record from a plurality of packets each including a header and a payload and (b) determining whether the plurality of packets correspond to a malicious flow using feature information based on the at least one record.

Operation (a) may include splitting the plurality of packets into at least one data stream on the basis of address information of the plurality of packets.

Operation (a) may further include rearranging the packets included in the at least one data stream according to sequence numbers of the packets included in the at least one data stream.

Operation (a) may further include removing the headers of the rearranged packets.

Operation (a) may further include parsing the payloads of the packets from which the headers are removed to extract the at least one record.

Operation (b) may include scaling the at least one record to a predetermined size.

The scaling of the at least one record may include performing zero padding on the at least one record to scale the at least one record to the predetermined size when a size of the at least one record is smaller than the predetermined size, and trimming the at least one record to scale the at least one record to the predetermined size when the size of the at least one record is larger than the predetermined size.

Operation (b) may further include extracting the feature information of the at least one record scaled to the predetermined size.

Operation (b) may further include determining whether the plurality of packets correspond to a malicious flow using the feature information.

The method may further include, before operation (a), receiving the plurality of packets each including the header and the payload.

According to another aspect of the present invention, there is provided a device for detecting malicious activity over an encrypted secure channel, the device including a controller configured to extract at least one record from a plurality of packets each including a header and a payload and determine whether the plurality of packets correspond to a malicious flow using feature information based on the at least one record.

The controller may split the plurality of packets into at least one data stream on the basis of address information of the plurality of packets.

The controller may rearrange the packets included in the at least one data stream according to sequence numbers of the packets included in the at least one data stream.

The controller may remove the headers of the rearranged packets.

The controller may extract the at least one record by parsing the payloads of the packets from which the headers are removed.

The controller may scale the at least one record to a predetermined size.

The controller may scale the at least one record to the predetermined size by performing zero padding on the at least one record when a size of the at least one record is smaller than the predetermined size and may scale the at least one record to the predetermined size by trimming the at least one record when the size of the at least one record is larger than the predetermined size.

The controller may extract the feature information of the at least one record scaled to the predetermined size.

The controller may determine whether the plurality of packets correspond to a malicious flow using the feature information.

The device may further include a communicator configured to receive the plurality of packets each including the header and the payload.

Details for achieving the objects will become clear with reference to exemplary embodiments to be described below together with the accompanying drawings.

However, the present invention is not limited to the embodiments disclosed below and may be embodied in various different forms. The embodiments are provided only to make the disclosure of the present invention thorough and complete and to fully convey the scope of the present invention to those skilled in the art to which the present invention pertains (hereinafter, “those of ordinary skill in the art”).

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram showing a secure socket layer (SSL) data stream conversion process according to an exemplary embodiment of the present invention;

FIG. 2 is a diagram showing the message flow of SSL tunneling according to an exemplary embodiment of the present invention;

FIG. 3 is a diagram showing a process for detecting malicious activity over an encrypted secure channel according to an exemplary embodiment of the present invention;

FIG. 4 is a diagram showing a feature extraction and classification process according to an exemplary embodiment of the present invention;

FIGS. 5A and 5B are diagrams showing performance graphs of an auto-encoder according to an exemplary embodiment of the present invention;

FIG. 6 is a set of diagrams showing visualization of feature information according to an exemplary embodiment of the present invention;

FIGS. 7A to 7C are diagrams showing classification performance graphs according to an exemplary embodiment of the present invention;

FIG. 8 is a flowchart illustrating a method of detecting malicious activity over an encrypted secure channel according to an exemplary embodiment; and

FIG. 9 is a diagram showing a functional configuration of a device for detecting malicious activity over an encrypted secure channel according to an exemplary embodiment.

### DETAILED DESCRIPTION OF EXEMPLARY EMBODIMENTS

The present invention may be variously changed and may have various embodiments. Therefore, specific embodiments will be illustrated in the accompanying drawings and described in detail.

Various features of the invention disclosed in the claims will be more easily understood in consideration of the drawings and the detailed description thereof. Devices, methods, manufacturing processes, and various embodiments disclosed in the specification are provided for illustration. The disclosed structural and functional features are provided so that those of ordinary skill in the art may specifically implement various embodiments rather than to limit the scope of the invention. Disclosed terms and sentences are provided to describe various disclosed features of the invention in a way that is easy to understand but not to limit the scope of the invention.

In the description of the present invention, when it is determined that a detailed description of relevant known technology may unnecessarily obscure the subject matter of the present invention, the detailed description thereof will be omitted.

Hereinafter, a method and device for detecting malicious activity over an encrypted secure channel according to exemplary embodiments of the present invention will be described.

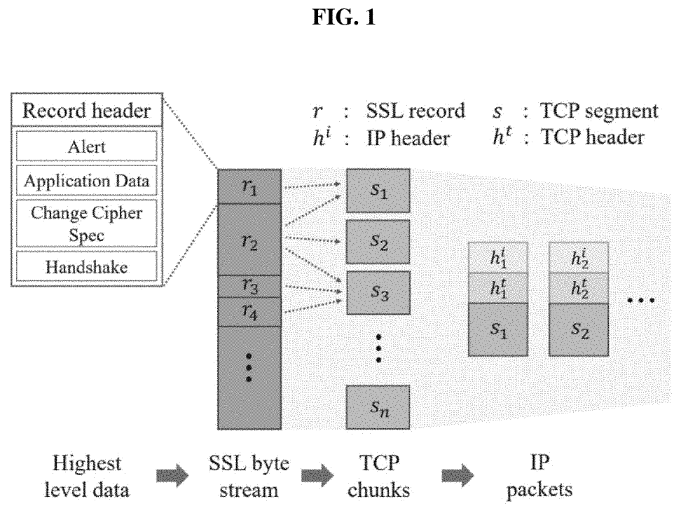

FIG. 1 is a diagram showing a secure socket layer (SSL) data stream conversion process according to an exemplary embodiment of the present invention.

Referring to FIG. 1, the SSL is also referred to as transport layer security (TLS) and may include a communication protocol which supports cryptographically protected tunneling for application-level data transmission.

The SSL is located on top of transmission control protocol/Internet protocol (TCP/IP) of a protocol stack and ensures confidentiality and integrity of upper layer (i.e., application layer) data. A basic unit of the SSL protocol may be a record.

According to an exemplary embodiment, a record header may include an alert message, application data, a change cipher spec, and a handshake.

When one host encounters an error or does not have any data to be delivered, the host may immediately transmit an alert message to notify a counterpart of session closure.

Application data may deliver payload content of application protocols (e.g., a hypertext transfer protocol (HTTP), a simple mail transfer protocol (SMTP), and a file transfer protocol (FTP)) which is segmented, compressed, and encrypted and decipherable only by the communicating party.

The change cipher spec may notify a receiver of some changes in a current encryption algorithm. The session may apply the newly agreed cipher spec to subsequent records.

At the beginning of the SSL session, two hosts exchange handshake type messages to authenticate each other and negotiate cryptographic parameters including a cryptographic product group and a supported SSL version.

While application data messages are completely encrypted, other messages, excluding some exceptions, may be exposed as general text including a larger amount of information than a TCP/IP header during the SSL session.

Each communicating party may prepare at least one record and attach the record header to each piece of data every time to send the data. A record frame is generally divided into several segments and may occupy consecutive bits within payloads of different packets.

Since a record delivers upper-layer data, a corresponding size may be larger than a maximum transmission unit (MTU) allowed for packet delivery. Even when the record size is small enough to enter a single packet, the SSL protocol may not transmit data blocks as often as possible.

Accordingly, a bundle of consecutive records may be put into a corresponding packet, and the remaining bits may be cut off and put into the next packet. SSL records may coalesce into a consecutive SSL byte stream and then split into fixed-length chunks called TCP segments in the same manner.

Each TCP segment is combined with IP and TCP headers to become a data frame called an IP packet. A sequence number of a TCP segment may be used to identify a packet order.

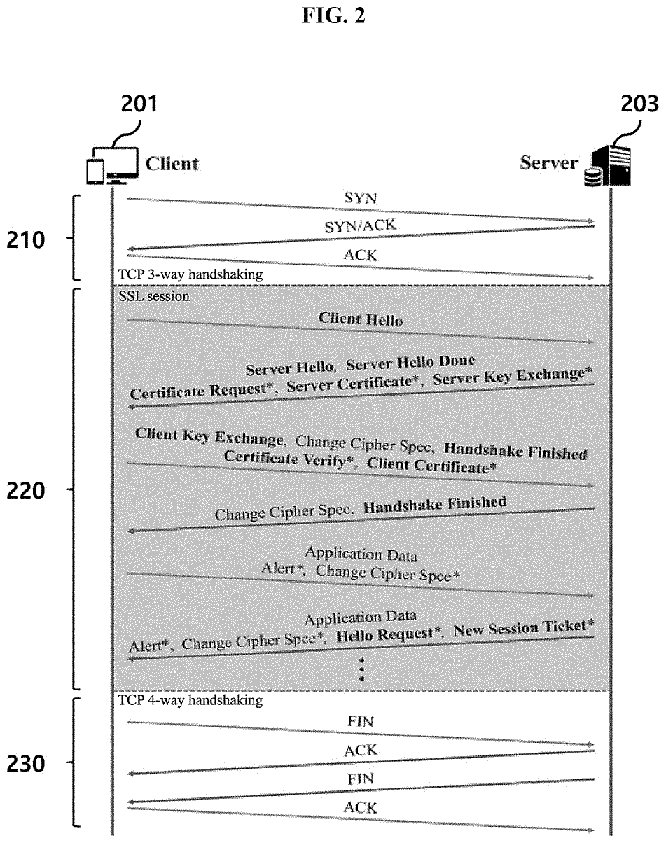

FIG. 2 is a diagram showing the message flow of SSL tunneling according to an exemplary embodiment of the present invention.

Referring to FIG. 2, the message flow of SSL tunneling may include a TCP 3-way handshake 210, an SSL session 220, and a TCP 4-way handshake 230.

In the TCP 3-way handshake 210, a client terminal 201 may serve as a host which initiates a session, and a server 203 may serve as a counterpart of the communication.

In this case, when the client terminal 201 sends a SYN to the server 203, the server 203 may reply with a SYN or ACK.

Subsequently, the client terminal 201 may transmit an ACK to the server 203.

In the SSL session 220, the client terminal 201 and the server 203 may deliver record messages to each other.

In FIG. 2, the message types in bold may belong to the handshake category, and the messages with an asterisk (*) are optional or transmitted depending on a situation.

After the client terminal 201 and the server 203 complete the authentication and key exchange, the client terminal 201 and the server 203 may send change cipher spec messages and proceed directly to a message notifying the end of the SSL handshake.

The two hosts may deliver application data until there is no more upper-layer data to be delivered.

During the application program data exchange process, a warning message may appear, and the client terminal 201 and the server 203 may renegotiate the cipher spec or begin an SSL handshake anew.

In the TCP 4-way handshake 230, the client terminal 201 and the server 203 may finish the communication. The client terminal 201 may notify the server 203 of the end of data exchange with a FIN flag, and the server 203 may reply with a FIN/ACK. The client terminal 201 may transmit an ACK as a final message of the session.

According to a service type and a user activity, the SSL handshake and data exchange operations may lengthen or shorten, and a ratio of each message type may widely vary.

Accordingly, it is possible to distinguish characteristics of malicious activities performed in a secure channel, such as an HTTP secure (HTTPS) port 443, by analyzing an SSL record exchange pattern.

In an exemplary embodiment, in the aspect of deep learning of spatial data, the success or failure of pattern recognition may be determined by a deep learning-based training model selection. In this case, various deep learning algorithms may be used, and each algorithm may process a specific type of data.

In particular, time-series data, text, and images having a grid-structured topology are not easily distinguishable with an existing multi-layer perceptron (MLP). In this type of data, corresponding elements (e.g., adjacent pixels of an image) may have explicit spatial relationships that the MLP does not recognize in an initial learning stage.

To improve understanding of connectivity between existing patterns of such data, convolutional neural network (CNN) and long short-term memory (LSTM) network architectures may be used.

A CNN may include a stack of three individual layers, each of which serves as one of convolution, activation, and pooling layers.

The convolution layer may include k randomly initialized filters F{F₁, F₂, . . . , Fₖ} which have a uniform size smaller than an input matrix I∈ [symbol] ^{n×m}.

In an exemplary embodiment, referring to Equation 1 below, a filter Fₛ∈ [symbol] ^{p×q} may be moved over the entire area of I for computing an output of a neuron I′ whose elements are the sums of dot products.

$${I}^{′} ( i , j ) = {\sum }_{b = 0}^{p - 1} {\sum }_{a = 0}^{q - 1} I ( i + a , j + b ) {F}_{s} ( a , b ) \qquad [ Equation 1 ]$$

In an exemplary embodiment, the convolution layer may generate k new feature images as described above.

Next, the activation layer may apply a nonlinear function, such as a rectified linear unit (ReLu), to a convoluted feature map while maintaining the size of volume.

After the activation operation, the pulling layer which compresses a feature matrix may be performed to improve the computation efficiency of a follow-up layer and retain some useful spatial information.

In an exemplary embodiment, max pooling may be applied to the pulling layer. Data may be divided into several consecutive sections, and the largest element may be taken from each section. A CNN algorithm may be executed through several sets of convolution, activation, and pulling layers.

Subsequently, the entire feature map is transformed into a flattened one-dimensional (1D) vector which may be supplied to a fully connected layer to generate a final output.

An LSTM network may refer to another neural network architecture for processing data such as a grid. An LSTM may use spatial locality in a different way than a CNN.

An LSTM network may process elements of a sequence one by one and share previous state information to detect a pattern over time. An LSTM layer includes a series of cells C={C₁, C₂, . . . , Cₖ}, and each cell may take an input vector and compute an output using an internal computation procedure.

The cells may be connected like a conveyor belt. Each LSTM cell may deliver an output vector (also referred to as a hidden state vector) and a cell state vector to a next cell. The two vectors and an incoming input may be used to compute a current hidden state and a next cell state.

A hidden state vector and a cell state vector may have m elements. In a cell Cₜ, an input and a previous hidden state vector hₜ₋₁ may be subjected to four computation units fₜ, iₜ, gₜ, oₜ∈ [symbol] ^{m}. For all the units, an input weight Uₜ∈ [symbol] ^{m×n}, a replicate weight Wₜ∈ [symbol] ^{m×m}, and a bias bₜ∈ [symbol] ^{m} for training an LSTM model may be present.

Among the units, gₜ has a tanh function for nonlinearity while the other units may apply sigmoid activation for the same purpose.

In an exemplary embodiment, referring to Equation 2 below, two state vectors hₜ and cₜ may be obtained by combining a previous cell state cₜ₋₁ and an output of each computation unit.

fₜ=σ(Uₜ^{f}xₜ+Wₜ^{f}hₜ₋₁+bₜ^{f})

iₜ=σ(Uₜⁱxₜ+Wₜⁱhₜ₋₁+bₜⁱ)

oₜ=σ(Uₜ^{o}xₜ+Wₜ^{o}hₜ₋₁+bₜ^{o})

gₜ=tanh(Uₜ^{g}xₜ+Wₜ^{g}hₜ₋₁+bₜ^{g})

cₜ=fₜo cₜ₋₁+iₜo gₜ

hₜ=oₜo tanh(cₜ) [Equation 2]

Here, “o” refers to the Hadamard product, and h₀ and c₀=0. After all cells compute hidden state vectors, the model may supply all or some output vectors to a follow-up layer.

When the purpose of the LSTM model is classification, a final output vector may be supplied to a feedforward neural network, and the LSTM may make an estimation using the softmax function.

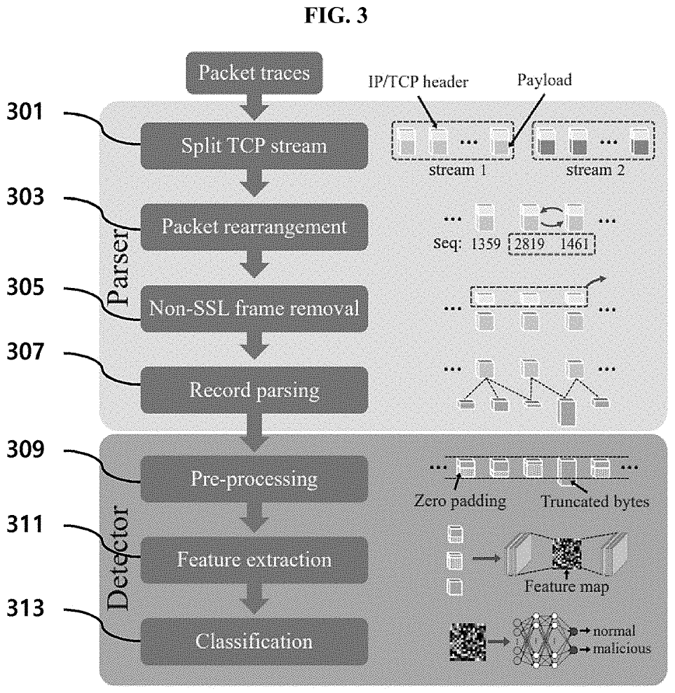

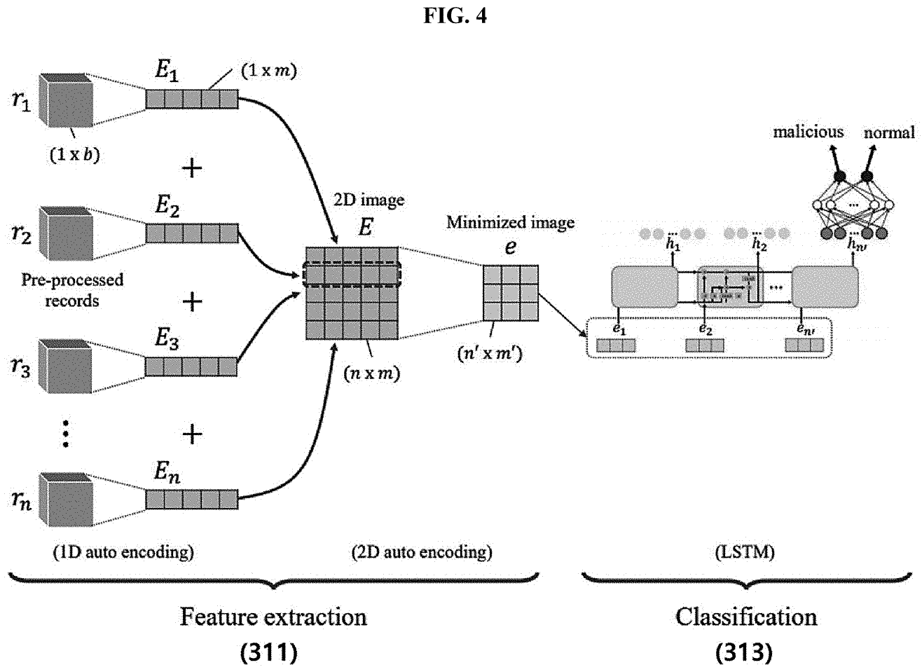

FIG. 3 is a diagram showing a process for detecting malicious activity over an encrypted secure channel according to an exemplary embodiment of the present invention, and FIG. 4 is a diagram showing a feature extraction and classification process according to an exemplary embodiment of the present invention.

Referring to FIG. 3, a process for detecting malicious activity over an encrypted secure channel may be divided into a parsing process and a detection process.

In an exemplary embodiment, a libpcap-based application for parsing collected packets and reassembling SSL records from packet-level data may be implemented. Packet data may be read from a previously saved pcap (or pcapng) format file or a live network interface for enabling real-time detection. Then, every time a new packet is read, a process as shown in Table 1 may be performed.

TABLE 1

1: procedure PARSERECORD(packet P, flow-table T)
2: S ← T [P] [symbol] associated TCP stream
3: if previous segment not captured then
4: S.queue.push(P) [symbol] delay the parsing order
5: return
6: else if P is retransmitted packet then
7: return
8: else if P has zero-sized payload then
9: return
10: else if P is either keep-alive or zero-window-probe then
11: return
12: end if
13: p ← P.payload [symbol] payload pointer
14: while p is not at the end of payload do
15: record header validation (first 5 bytes)
16: 1 ← current record-length
17: extract p-th ~ (p + 1 + 4)-th byte values
18: p ← p + 1 + 5
19: end while
20: P’ ← S.queue.front [symbol] packet with lowest seq
21: if P’.seq == S.nextSEQ then
22: ParseRecord(P’, T) [symbol] parse the reserved packet
23: end if
24: end procedure

In a TCP stream split operation 301, traffic flow may be split according to each TCP stream. In an exemplary embodiment, all packets having the same pair of source/destination IP addresses and port numbers (4-tuple) for each TCP stream may belong to the same connection.

Since SSL is the upper layer of TCP, a parsing module may delete non-TCP/IP packets. The parsing module manages a flow table whose keys are hashed with the above four criteria, and each hashed result is mapped to a TCP stream index number.

When a host sends an SYN packet with a hash value already stored in the flow table, this indicates a new session. Accordingly, the flow table assigns a new stream index to the flow.

In a packet rearrangement operation 303, TCP SEQ/ACK numbers are analyzed to confirm the right order of packets. When a current sequence number is larger than a next expected sequence number, it is obvious that several packets have not been captured, and this may denote that subsequent record information has also been damaged.

In this case, even when the next packet is transmitted without change, it may not be possible to parse records any more. This may be because there is no way to detect the region of the next packet when there is no record length field information in a record header.

Such an out-of-sequence packet sequence may be seen very frequently in an actual network environment and thus stored in a queue arranged in ascending order of sequence number.

For a reserved packet inspection, a first element of the packet queue may be taken out before the procedure is completed. When the sequence number is identical to the next expected sequence number, the same procedure may be started for a corresponding packet.

Otherwise, the current procedure may be completed, and a packet arriving next may be waited for. On the other hand, when the current sequence number is smaller than the next expected sequence number, there may be a probability of retransmission. Such a packet may be considered as a duplicated data segment and ignored.

In a non-SSL frame removal operation 305, TCP/IP headers may be removed, and packets whose remaining segment has a size of 0 may be filtered out.

TCP/IP headers are no longer necessary for a next process and may be excluded to prevent learning of an unrelated function such as an IP address or a port number.

In addition, a record parsing process may be omitted for keep-alive and zero-window-probe packets which do not include a record segment and do not have a payload size of 0.

In a record parsing operation 307, payloads may be analyzed to extract fragmented records from the payloads.

Since records are spread over TCP segments, it may be determined whether a combined payload is a series of record chunks in a heuristic way, and each record may be separated according to the following rules.

1) The first byte corresponds to a record message type and may be in the range of 0x14 to 0x17.

2) The next two bytes are related to an SSL version. The former may be 0x03, and the value of the last one may be in the range of 0x00 to 0x03.

3) The SSL version field may be followed by a record length which represents a data block size exclusive of a record header. Since the field occupies two bytes, the maximum size of a record payload may be 65,535.

4) A record header may represent that a 5-byte region contains the values described in 1) to 3). When a record length is 1, the parsing module may separate a following 1+5 byte region from the payload.

Each record is directly connected to the next record. Accordingly, when a payload pointer moves to the end of a designated record, the beginning of a new record header may be found.

A record size may exceed the maximum payload size. Therefore, when the payload pointer does not arrive at the end of the record, remaining record content may be confirmed in the subsequent payload.

Series of records received by the client terminal 201 and the server 203 may be aggregated separately. Meanwhile, the order of parsed records may be chronologically retained to merge the two independent record sequences into a single sorted sequence.

Therefore, the acquired data sequence may include all statistical characteristics which are important in the relationship between signature-type information and an adjacent record message.

In a pre-processing operation 309, first n records r₁, r₂, . . . , rₙ obtained from the given record sequence may be arranged, and each of the n records r₁, r₂, . . . , rₙ may be trimmed to b bytes.

The record header is always transparent, but the record payload following the record header may be an encrypted region which is uninformative for a traffic classification task.

Any record payload transmitted after the end of the handshake may be protected according to negotiated key materials until one of the hosts sends a special notification message (e.g., a hello request, KeyUpdate, or new session ticket message) which causes an additional handshake during the session.

Therefore, when a record corresponds to such a case, the payload content may be replaced with a series of zero values.

When the size of a record is smaller than b bytes, the record may be padded with a couple of zeros through zero padding to confirm whether all pieces of input data have a fixed size.

For a session which terminates with less than n records, zero vectors with a size of b may be added to the end of the record sequence so that the total number of records may become n.

Also, the feature map which divides each byte value by the maximum possible value (255) may be normalized so that all elements in an input vector may have values between 0 and 1.

In a feature extraction operation 311, the total amount of record content is expected to exceed a value which may be solved with a pattern-matching strategy, and thus dimension reduction may be performed.

For the dimension reduction, an auto-encoder technology may be applied. Also, the record is a byte stream, and thus a CNN may be deployed as an encoder and a decoder.

In an exemplary embodiment, referring to FIG. 4, a detection module may include two stacked convolutional auto-encoders for two different purposes, which are learning of features of a single record and learning of features of the overall record sequence.

Each 1D auto-encoder includes four encoding layers and four decoding layers, and the encoding layers may generate a series of m-dimension reduction vectors (E₁, E₂, . . . Eₙ∈ [symbol] ^{m}).

The generated vectors E₁, E₂, . . . , and Eₙ may be spliced to form a two-dimensional (2D) image-like input E∈R^{n×m} of a 2D auto-encoder, and the 2D auto-encoder may perform another feature learning task.

This neural network has the same number of encoding/decoding layers as a previous auto-encoder. However, when feature dimensions increase from 1D to 2D, 2D convolution may apply for data reconstruction.

In training, the neural network may be trained to better represent the spatial relationship between consecutive records.

As a result, the neural network may output a reduced feature map e which is an actual input required for classification, that is, a minimized image e.

In a classification operation 313, the minimized image e may be input, and an output may be generated through a series of intermediate computations. In this case, a categorical value of the output may be 1 (malicious traffic) or 0 (normal traffic).

Since the LSTM network does not accept a 2D image without reconstructing the original data, the input e is divided into e₁, e₂, . . . , and eₙ₀ rows, and these vectors may be executed through LSTM cells.

In consideration of the overfitting problem and throughput, a shallow neural network including three LSTM layers and four fully-connected hidden layers may be used.

In other words, an auto-encoder may be used to encode SSL records, and an encoded SSL record sequence may be generated from each encrypted traffic flow.

Each traffic flow may be characterized by an encoded SSL record sequence. Feature information of an SSL encryption flow may be obtained by applying the auto-encoder to a training dataset of sequential SSL records in several sampled traffic flows.

In an exemplary embodiment, an LSTM model may be used as a classifier to which a feature vector extracted to determine a type of SSL encryption flow is supplied.

It is seen below that a classification approach according to the present invention has good separability between benign traffic flow and malicious traffic flow.

For performance evaluation, two metrics may be used: a detection rate (DR) and a false alarm rate (FAR). A main task may be classification on samples tagged with “1” (malicious) or “0” (benign).

The DR may be a ratio of instances classified into a malicious category, whereas the FAR may be a ratio of benign instances incorrectly classified into the malicious category. These measured values may be represented by Equation 3 below.

$$DR = \frac{TP}{TP + FN} \\ FAR = \frac{FP}{FP + TN} \qquad [ Equation 3 ]$$

Here, TP denotes the number of tuples correctly predicted as malicious traffic, FP denotes the number of tuples misclassified as malicious traffic, TN denotes the number of tuples correctly predicted as normal traffic, and FN denotes the number of tuples incorrectly predicted as normal traffic.

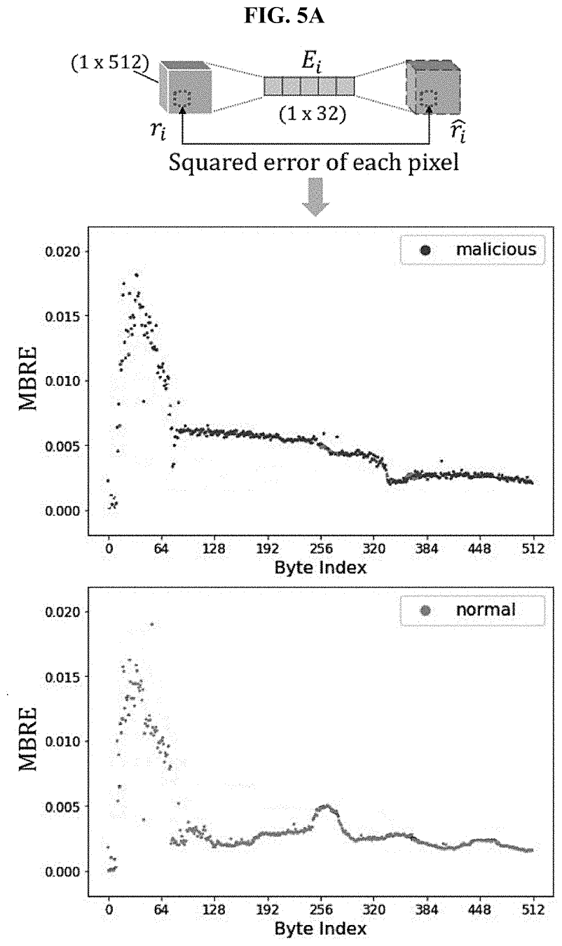

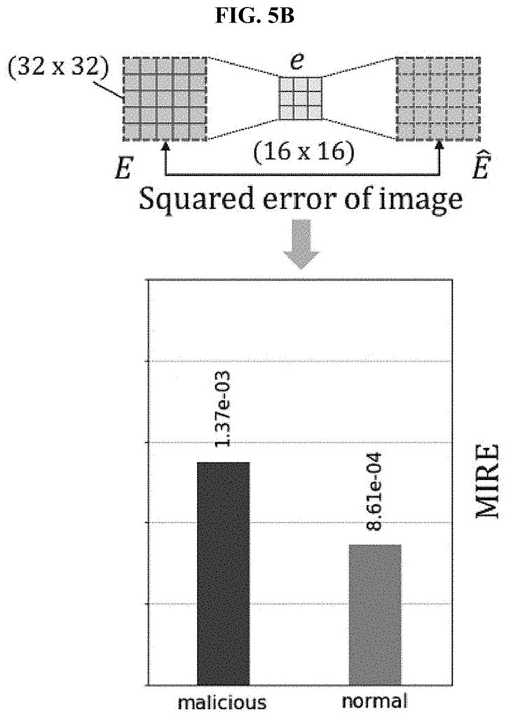

FIGS. 5A and 5B are diagrams showing performance graphs of an auto-encoder according to an exemplary embodiment of the present invention.

Referring to FIGS. 5A and 5B, reconstruction errors occurring in two autoencoding processes may be confirmed. As shown in FIG. 5A, when b=512 and m=32, 1D autoencoding may be performed for record feature extraction while a mean square error between the original record byte values and played record byte values is calculated at each position

The auto-encoder achieves lower errors for a record header, but the value suddenly increases at a sixth index at which a record payload begins.

In an initial byte region, some handshake messages, which are named client/server hello and aim to generate key materials, include a random field having a 32-byte length. Accordingly, there are wide fluctuations in error.

Subsequently, with an increase in byte index, reconstruction errors are reduced. This may result from an increase in the number of zero-padded positions.

In an exemplary embodiment, a malware traffic sample may show higher reconstruction errors than a benign sample at all byte positions.

Also, as shown in FIG. 5B, a next 2D autoencoding operation is affected. As a result, when n′ and m′ are set to 16, a reconstruction error of a malware image is about 1.6 times that of a general sample.

Such a phenomenon may be explained with a disparate configuration of a malicious record message. A change cipher spec message or an alert record message may be relatively short and may occupy a small portion of the overall conversation.

Instead, it may be assumed that most differences observed, although the frequency tends to decrease as the session continues, are related to a handshake message. Interestingly, nearly 92.8% of general servers bypass an authentication verification operation while 94.1% of command and control (C&C) servers continuously send a certificate message to victim hosts regarding all session settings.

This may be particularly important because all servers have unique certificates which generally have far more diversified content than other record messages.

This may degrade an encoder's performance of sequentially identifying representative functions from record frames. When a negotiated key exchange mechanism requires key information of a server certificate, such message generation may be necessary for a server side.

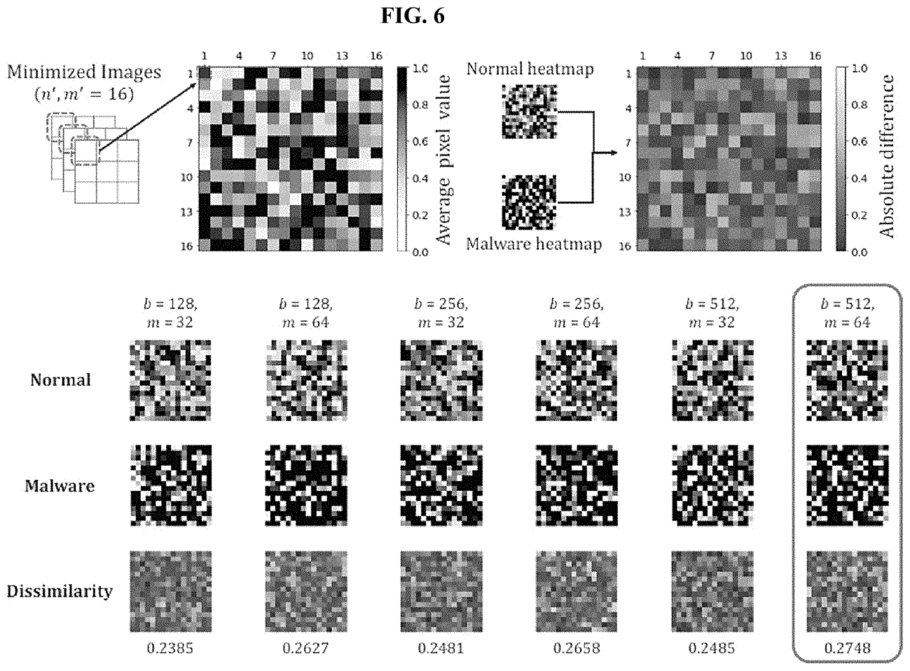

FIG. 6 is a set of diagrams showing visualization of feature information according to an exemplary embodiment of the present invention.

Referring to FIG. 6, flow patterns of two categories of SSL connections may be compared in terms of flow similarity in connection with a compressed record sequence image.

When an intermediate product is visualized before a classification operation, the detection module may confirm types of patterns to be learned in input data. The grayscale image of FIG. 6 may represent an average heatmap of output matrices obtained from 2D auto-encoders for several parameter (b and m) settings.

In the first and second rows, pixel values are normalized, and when the value becomes closer to 1.0, the pixel is colored with a darker tone.

Since the brightness of a single pixel may vary depending on a model weight, all of six 2D auto-encoders may generate different textures from malicious and benign groups.

However, when compared in the same column, all pairs of two different flow images may show an unusual similarity at a darker position. In this result, the overall shape of an encoded feature image enables people to recognize the feature at the level of human vision, and thus the detection task is significantly meaningful.

For clarity, dissimilarity may be evaluated with the absolute difference between pixels at each position in two record heatmaps. When the parameter b or m is increased, a relatively high dissimilarity is returned. This may mean that an encoded image may be distinguished more clearly. An approach of increasing the two values can make a reconstruction process more effective by widening a feature application range and reducing feature loss.

Also, in the case of the highest dissimilarity (0.2748 when b=512 and m=64), the best detection performance may be obtained.

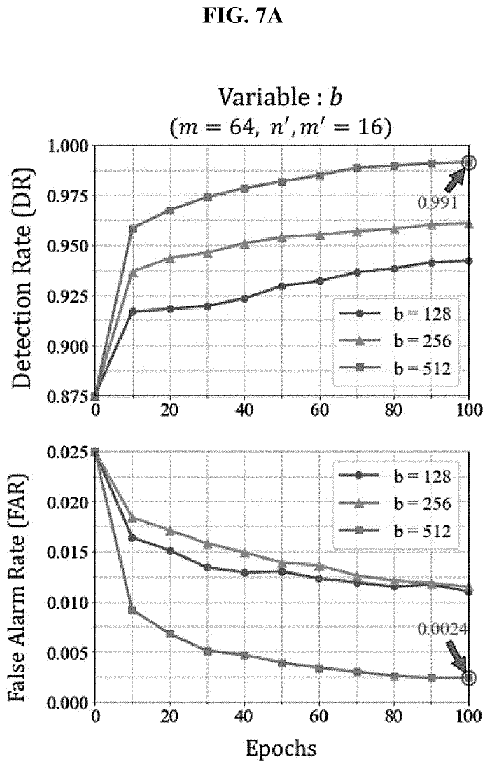

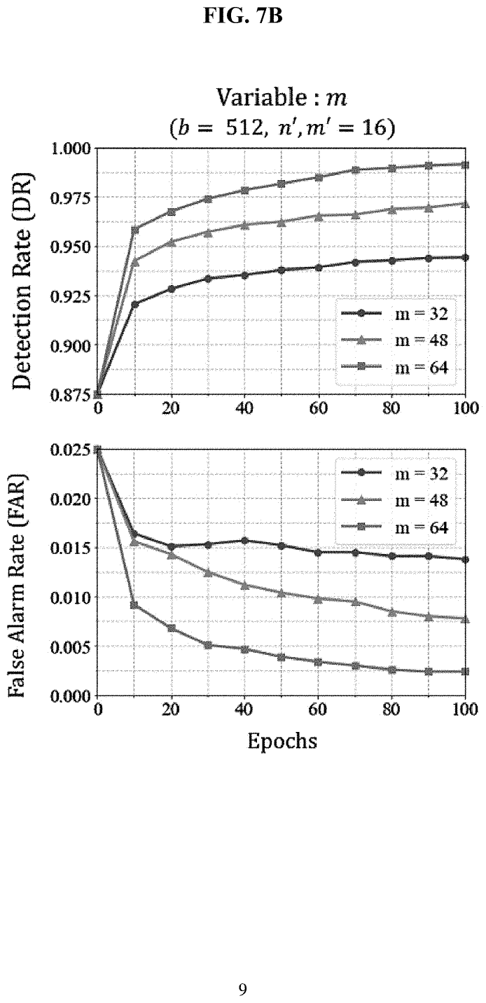

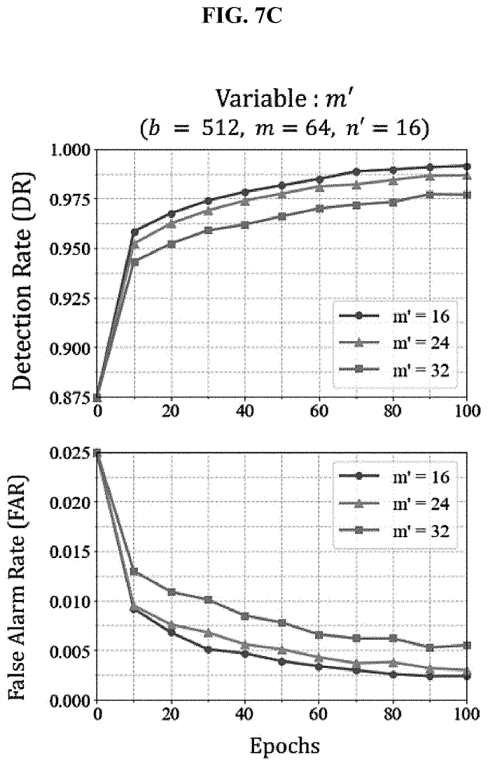

FIGS. 7A to 7C are diagrams showing classification performance graphs according to an exemplary embodiment of the present invention.

Referring to FIGS. 7A to 7C, classification performance may be measured by applying three different values to parameters b, m, and m′.

Referring to FIG. 7A, both DR and FAR are positively affected by an increase in the value of b.

When b=512 within the first 100 epochs, the best DR (0.991) and FAR (0.0024) are achieved. In another case (b=128 or 256), a higher DR is obtained as the training proceeds. However, there is a minimum difference of about 3%, and this result fails to catch up with the best result.

After 80 epochs, FAR values are not reduced and remain around 0.011. In other words, the corresponding two models may incorrectly identify about 0.9% more non-malicious SSL traffic flow compared to the best case.

Referring to FIG. 7B, when a higher m is selected, a speed for reaching an optimal DR and FAR is increased.

The two results of FIGS. 7A and 7B coincide with the expectation of a visualization result because a difference between two traffic image categories is significantly affected by b or m.

When larger values are selected for b and m, a learning or classification time is not actually increased very much. A total elapsed time to obtain a final output may be 136.1 seconds when b=128 and m=32 and may be 171.0 seconds when b=512 and m=64.

Since most of the time is spent in parsing records from a pcap file which may be solved by a real-time framework capturing function according to the present invention, it is reasonable to select hyperparameters which are higher than or closer to hyperparameters of the best case possible.

Referring to FIG. 7C, the evaluation metrics may be measured with several values of m′. In this case, the classifier provides the best result when the selected parameter has the smallest value of 16.

When m′=24 (0.2499) and m′=32 (0.1550), a performance gap is very small between a general heatmap and a malicious code heatmap. This may result from noise which is generated in a subsequent 2D autoencoding operation in which an input has already undergone an encoding procedure.

When the parameter b is changed from 256 to 512, a FAR value is reduced so much that it is necessary to review FAR performance in terms of preprocessed record size. Such a difference results from the presence of 257 to 512 record byte fields, and there are two handshake messages showing a considerable difference in record size such as client and server hello messages.

On average, lengths of these two messages are 381.1 and 544.8 in the case of normal traffic samples, and a malicious traffic group may show relatively short hello message lengths (162.2 and 172.6). One factor associated with the comparison result is an SSL extension, which is optimal data appended to several handshake type payloads and providing various functions allowing efficient session establishment or data exchange in a particular environment.

In an exemplary embodiment, the detection architecture may be compared with a general flow-level inspection model on the same dataset.

To implement a flow-based classifier, a traffic analyzer for extracting 80 or more flow statistic features may be used.

Some available features having invalid (negative, missing, or infinite) values in IP addresses/port numbers and several attribute tuples are removed, and the remaining 74 features may be used for flow-level inspection.

Since all the attributes are numerals in different ranges, min-max normalization may be applied to a given set of attributes so that the minimum value of each feature element becomes 0 and the maximum value becomes 1.

While a preprocessed flow feature vector is in the form of a 1D array which is difficult for an LSTM or a CNN to directly learn, a record feature map may be flattened into input data such as an array.

Accordingly, in a comparative experiment, several types of machine learning technologies, such as fully-connected (FC) network, logistic regression (LR), Naïve Bayes (NB), K nearest neighbors (KNN), decision tree (DT), random forest (RF), and support vector machine (SVM), may be used to evaluate all existing methods and the flow-level detection algorithm.

In an exemplary embodiment, Table 2 below shows the performance of the proposed classification model compared to another classifier whose input is a flattened record image or a flow statistical feature vector.

TABLE 2

| | Detection | False Alarm |
|---|---|---|
| Architecture | Rate (DR) | Rate (FAR) |
| Record-level detection | | |
| (with original input) | | |
| LSTM | 0.991 | 0.002 |
| CNN | 0.975 | 0.006 |
| Record-level detection | | |
| (with flattened input) | | |
| FC (5 layers) | 0.955 | 0.012 |
| LR | 0.923 | 0.017 |
| NB | 0.976 | 0.332 |
| KNN | 0.963 | 0.010 |
| DT | 0.938 | 0.009 |
| RF | 0.939 | 0.012 |
| SVM | 0.923 | 0.016 |
| Flow-level detection | | |
| (with 74 flow features) | | |
| FC (5 layers) | 0.917 | 0.018 |
| LR | 0.518 | 0.060 |
| NB | 0.900 | 0.715 |
| KNN | 0.900 | 0.017 |
| DT | 0.898 | 0.021 |
| RF | 0.860 | 0.005 |
| SVM | 0.542 | 0.048 |

When the inspection algorithm according to the present invention is applied, all the classification algorithms are performed better. In particular, LR and SVM results show a large difference between the introduced two methods.

While the flow-level classifier succeeds in identifying about half of malicious traffic flows using LR and SVM algorithms, the method according to the present invention can increase the DR to more than 0.9 and reduce the FAR to about ⅓.

Even the best DR performance of a flow-level inspection obtained from a 5-layer FC model is 0.006 lower than the worst result of a record-level inspection (however, an NB classifier has an important disadvantage in terms of FAR).

In other words, the best DR performance is achieved by the LSTM model rather than the CNN model because of a small image size resulting from several autoencoding processes which eventually limit a deeper convolutional task. This may describe how the FC architecture is performed better compared to the CNN architecture.

According to the present invention, a new malicious traffic detection method for monitoring an encrypted SSL channel can be proposed. According to the present invention, it is possible to acquire feature information from time-series data named SSL records and spatial dependencies between the records.

Each record represents a unique encryption region and distributed over data streams. A great deal of noise occurs in an input function, and a sensing speed is slightly insufficient. Accordingly, record parsing may be performed instead of using raw packet data. The parsed record sequences may reflect the unique behavioral characteristics of a communicating party and provide a wider feature map than TCP/IP-level metadata.

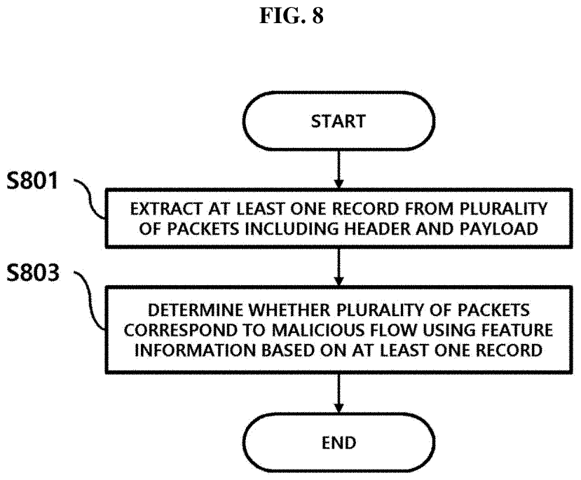

FIG. 8 is a flowchart illustrating a method of detecting malicious activity over an encrypted secure channel according to an exemplary embodiment. In an exemplary embodiment, each operation of FIG. 8 may be performed by the client terminal 201 or the server 203.

Referring to FIG. 8, in operation S801, at least one record is extracted from a plurality of packets including a header and a payload.

For example, the header may include an IP header and a TCP header. Also, the payload may include a TCP segment.

For example, the record may include an SSL record.

In an exemplary embodiment, the plurality of packets may be split into at least one data stream on the basis of address information of the plurality of packets.

In an exemplary embodiment, the packets included in the at least one data stream may be rearranged according to sequence numbers of the packets included in the at least one data stream.

In an exemplary embodiment, headers of the rearranged packets may be removed.

In an exemplary embodiment, payloads included in the packets from which the headers are removed are parsed to extract at least one record.

In operation S803, whether the plurality of packets correspond to a malicious flow may be determined using feature information based on the at least one record. In an exemplary embodiment, whether the plurality of packets correspond to a malicious flow may be determined by applying the at least one record to a machine learning model.

In an exemplary embodiment, the at least one record may be scaled to a predetermined size. Specifically, when the at least one record is smaller than the predetermined size, zero padding may be performed on the at least one record so that the at least one record may be scaled to the predetermined size.

Also, when the at least one record is larger than the predetermined size, the at least one record may be trimmed so that the at least one record may be scaled to the predetermined size.

In an exemplary embodiment, feature information may be extracted from the at least one record scaled to the predetermined size.

In an exemplary embodiment, whether the plurality of packets correspond to a malicious flow may be determined using the feature information.

In an exemplary embodiment, before operation S801, the plurality of packets including the header and the payload may be received.

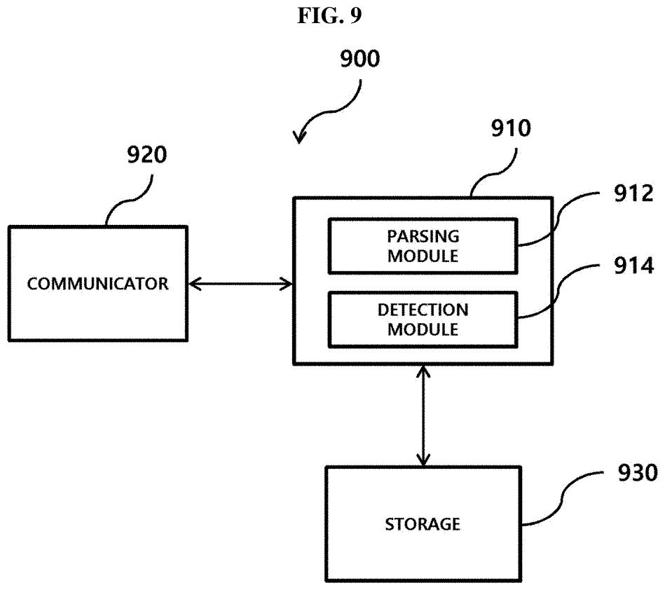

FIG. 9 is a diagram showing a functional configuration of a device 900 for detecting malicious activity over an encrypted secure channel according to an exemplary embodiment. In an exemplary embodiment, the malicious activity detection device 900 may be implemented as the client terminal 201 or the server 203.

Referring to FIG. 9, the malicious activity detection device 900 may include a controller 910, a communicator 920, and a storage 930.

The controller 910 may extract at least one record from a plurality of packets including a header and a payload and determine whether the plurality of packets correspond to a malicious flow using feature information based on the at least one record.

In an exemplary embodiment, the controller 910 may include a parsing module 912 and a detection module 914.

In an exemplary embodiment, the parsing module 912 may split the plurality of packets into at least one data stream on the basis of address information of the plurality of packets, rearrange the packets included in the at least one data stream according to sequence numbers of the packets included in the at least one data stream, remove headers of the rearranged packets, and extract payloads included in the packets from which the headers are removed, thereby extracting at least one record.

In an exemplary embodiment, the detection module 914 may scale the at least one record to a predetermined size, extract feature information from the at least one record scaled to the predetermined size, and determine whether the plurality of packets correspond to a malicious flow using feature information.

In an exemplary embodiment, the controller 910 may include at least one processor or microprocessor or may be a part of a processor. Also, the controller 910 may be referred to as a communication processor (CP). The controller 910 may control operations of the malicious activity detection device 900 according to various exemplary embodiments of the present invention.

The communicator 920 may receive a plurality of packets including a header and a payload.

In an exemplary embodiment, the communicator 920 may include at least one of a wired communication module and a wireless communication module. The whole or a part of the communicator 920 may be referred to as a “transmitter,” “receiver,” or “transceiver.”

The storage 930 may store the plurality of packets including a header and a payload.

In an exemplary embodiment, the storage 930 may be a volatile memory, a non-volatile memory, or a combination of a volatile memory and a non-volatile memory. The storage 930 may provide the stored data according to a request of the controller 910.

Referring to FIG. 9, the malicious activity detection device 900 may include the controller 910, the communicator 920, and the storage 930. In various exemplary embodiments of the present invention, the elements illustrated in FIG. 9 are not essential for the malicious activity detection device 900, and the malicious activity detection device 900 may be implemented as more or fewer elements than the elements illustrated in FIG. 9.

According to an exemplary embodiment of the present invention, it is possible to perform new malicious traffic detection for inspecting a traffic flow in an SSL channel by analyzing SSL records.

Effects of the present invention are not limited to those described above, and potential effects expected from the technical characteristics of the present invention will be clearly understood from the above description.

The above-described embodiments are merely illustrative of the technical spirit of the present invention, and those of ordinary skill in the art can make various modifications and alternations without departing from the essential characteristics of the present invention.

Various embodiments disclosed herein may be performed out of order, simultaneously, or separately.

According to an embodiment, at least one operation in each drawing described herein may be omitted or added, performed in the reverse order, or performed simultaneously.

The exemplary embodiments disclosed herein are not intended to limit but to describe the technical spirit of the present invention, and the scope of the present invention is not limited thereto.

The scope of the present invention should be defined by the claims, and all technical ideas equivalent thereto should be understood as falling within the scope of the present invention.

What is claimed is:

1. A method of detecting malicious activity over an encrypted secure channel, the method comprising:
(a) extracting at least one record from a plurality of packets each including a header and a payload; and
(b) determining whether the plurality of packets correspond to a malicious flow using feature information based on the at least one record.

2. The method of claim 1, wherein operation (a) comprises splitting the plurality of packets into at least one data stream on the basis of address information of the plurality of packets.

3. The method of claim 2, wherein operation (a) further comprises rearranging the packets included in the at least one data stream according to sequence numbers of the packets included in the at least one data stream.

4. The method of claim 3, wherein operation (a) further comprises removing the headers of the rearranged packets.

5. The method of claim 4, wherein operation (a) further comprises parsing the payloads of the packets from which the headers are removed to extract the at least one record.

6. The method of claim 1, wherein operation (b) comprises scaling the at least one record to a predetermined size.

7. The method of claim 6, wherein the scaling of the at least one record comprises:
performing zero padding on the at least one record to scale the at least one record to the predetermined size when a size of the at least one record is smaller than the predetermined size; and
trimming the at least one record to scale the at least one record to the predetermined size when the size of the at least one record is larger than the predetermined size.

8. The method of claim 6, wherein operation (b) further comprises extracting the feature information of the at least one record scaled to the predetermined size.

9. The method of claim 8, wherein operation (b) further comprises determining whether the plurality of packets correspond to a malicious flow using the feature information.

10. The method of claim 1, further comprising, before operation (a), receiving the plurality of packets each including the header and the payload.

11. A device for detecting malicious activity over an encrypted secure channel, the device comprising:
a controller configured to extract at least one record from a plurality of packets each including a header and a payload and determine whether the plurality of packets correspond to a malicious flow using feature information based on the at least one record.

12. The device of claim 11, wherein the controller splits the plurality of packets into at least one data stream on the basis of address information of the plurality of packets.

13. The device of claim 12, wherein the controller rearranges the packets included in the at least one data stream according to sequence numbers of the packets included in the at least one data stream.

14. The device of claim 13, wherein the controller removes the headers of the rearranged packets.

15. The device of claim 14, wherein the controller extracts the at least one record by parsing the payloads of the packets from which the headers are removed.

16. The device of claim 11, wherein the controller scales the at least one record to a predetermined size.

17. The device of claim 16, wherein the controller scales the at least one record to the predetermined size by performing zero padding on the at least one record when a size of the at least one record is smaller than the predetermined size and scales the at least one record to the predetermined size by trimming the at least one record when the size of the at least one record is larger than the predetermined size.

18. The device of claim 16, wherein the controller extracts the feature information of the at least one record scaled to the predetermined size.

19. The device of claim 18, wherein the controller determines whether the plurality of packets correspond to a malicious flow using the feature information.

20. The device of claim 11, further comprising a communicator configured to receive the plurality of packets each including the header and the payload.
